(19) United States
(12) Patent Application Publication
(10) Pub. No.: US 2014/0032158 A1
(43) Pub. Date: Jan. 30, 2014

(54) AUTOMATED TEST SYSTEM

(71) Applicant: Hengyi Liang, Atlanta, GA (US)

(72) Inventor: Hengyi Liang, Atlanta, GA (US)

(73) Assignee: Altran Solutions Corp., Boston, MA (US)

(21) Appl. No.: 13/560,768

(22) Filed: Jul. 27, 2012

(51) Int. Cl. G06F 19/00

(52) U.S. Cl. 702/122

(57) ABSTRACT

Systems and methods for automated testing of a distributed control system are provided. The automated test system includes a master station having a processing unit operably coupled to a user interface and a master wireless unit; and at least one remote station. Each remote station includes at least one output module to send outputs to a unit under test, at least one input module to receive inputs from the unit under test and a remote wireless unit operably coupled to the at least one output module and the at least one input module. The master station is configured to transmit outputs to the remote station by wireless communication and to receive inputs from the remote station by wireless communication. The received inputs are representative of a condition of the unit under test.

### FIELD OF THE INVENTION

This invention relates to automated test systems and methods and, more particularly, to automated test systems and methods configured for automated testing of a distributed control system in a large facility, such as for example a nuclear power plant.

### BACKGROUND

The control system for a nuclear power plant is an example of a very large and complex system. The control system includes elements distributed in different locations in the power plant and may have thousands of inputs and outputs. The distributed control system may include redundant controller modules, communication modules and input/output modules. The modules of the distributed control system may be installed in different control panels in different locations in the power plant. Communication may be handled by a control network with transmission over twisted pair, coaxial cable or fiber optic cable. A server and/or applications processor may be included in the system for extra computational, data collection and reporting capability. The heart of a nuclear control system is the reactor protection system, which alone may have more than 5,000 process I/O points. An automated test system is desirable for automating the testing process and thus improving efficiency and reducing human errors in the test execution.

### SUMMARY OF THE INVENTION

The architecture of the automated test system includes a master station and at least one, typically multiple, remote stations. The remote stations may be in different locations, according to the locations of the control system units being tested. The remote stations communicate with the master station by wireless communication. The master station controls the transmission of outputs to the remote stations and receiving inputs from the remote stations. The remote stations in turn send the outputs to a unit under test and receive inputs from the unit under test. Different numbers of remote stations can be utilized according to the application. Each remote station may include one or more output modules and one or more input modules. The remote stations and the master station are configured for portability to facilitate installation in close proximity to components of the distributed control system under test.

According to a first aspect of the invention, an automated test system is provided. The automated test system comprises a master station including a processing unit operably coupled to a user interface and a master wireless unit; and at least one remote station. The at least one remote station includes at least one output module to send outputs to a unit under test, at least one input module to receive inputs from the unit under test and a remote wireless unit operably coupled to the at least one output module and the at least one input module. The master station is configured to transmit outputs to the remote station by wireless communication and to receive inputs from the remote station by wireless communication. The received inputs are representative of a condition of the unit under test.

According to a second aspect of the invention, a method for automated testing of a control system is provided. The method comprises generating an output at a master station; transmitting the output from the master station to a remote station by wireless communication; transmitting the output from the remote station to a unit under test; receiving, by the remote station, an input from the unit under test in response to the output; transmitting the input from the remote station to the master station by wireless communication; and receiving, by the master station, the input, the received input being indicative of a condition of the unit under test.

According to a third aspect of the invention, an automated test system comprises a master station including a processing unit operably coupled to a user interface and a master wireless unit; and multiple remote stations configured for wireless communication with the master station and for wired communication with respective units under test, each remote station including one or more output modules to send outputs to a respective unit under test, one or more input modules to receive inputs from the respective unit under test and a remote wireless unit operably coupled to the one or more output modules and the one or more input modules, wherein the master station is configured to transmit outputs to each of the remote stations by wireless communication and to receive inputs from each of the remote stations by wireless communication, the received inputs being representative of one or more conditions of the units under test.

### BRIEF DESCRIPTION OF DRAWINGS

For a better understanding of the present invention, reference is made to the accompanying drawings, which are incorporated herein by reference and in which:

FIG. 1 is a schematic block diagram of an automated test system in accordance with embodiments of the invention;

FIG. 2 is a schematic block diagram of a master station in accordance with embodiments of the invention;

FIG. 3 is a schematic block diagram of a remote station in accordance with embodiments of the invention;

FIG. 4 is a flow chart of a process for transmitting analog outputs to a remote station in accordance with embodiments of the invention;

FIG. 5 is a flow chart of a process for receiving analog inputs from a remote station in accordance with embodiments of the invention;

FIG. 6 is a flow chart of automatic system operation in accordance with embodiments of the invention;

FIG. 7 is a flow chart of manual system operation in accordance with embodiments of the invention; and

FIG. 8 is a schematic block diagram of a computing system used in the master station in accordance with embodiments of the invention.

### DETAILED DESCRIPTION

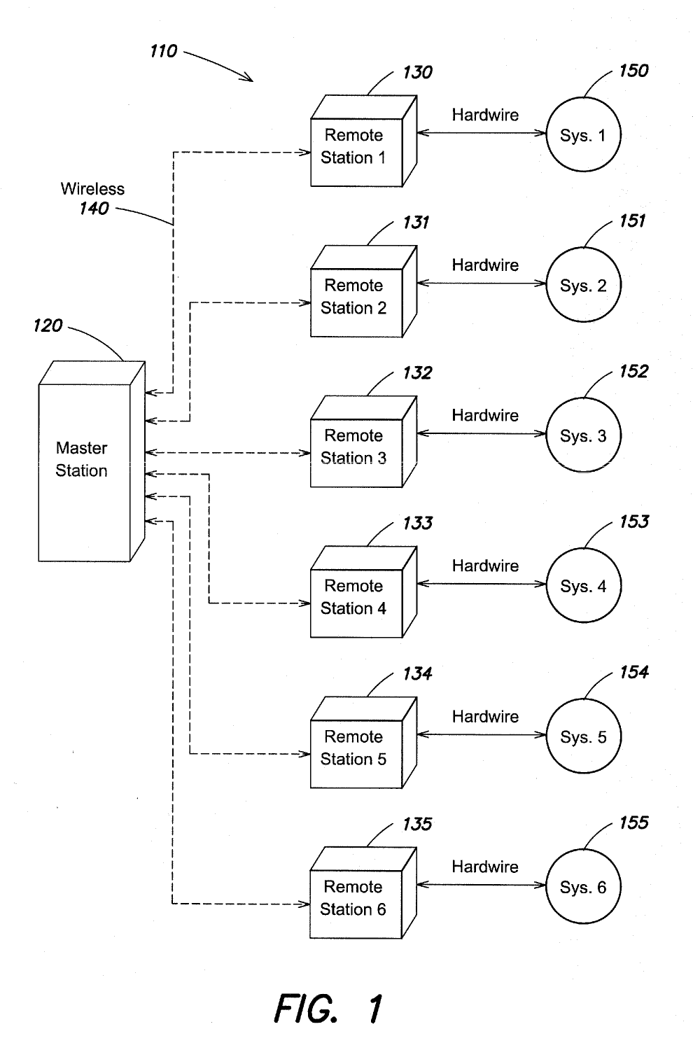

A schematic block diagram of an automated test system in accordance with embodiments of the invention is shown in FIG. 1. An automated test system 110 includes a master station 120 and at least one remote station. In the example of FIG. 1, the system 110 includes remote stations 130, 131, 132, 133, 134 and 135. In general, the system may include any required number of remote stations within the addressing capability of the master station 120. The master station 120 communicates with each of the remote stations 130, 131, 132, 133, 134 and 135 by wireless communication, as indicated by wireless link 140. Each of the remote stations is connected by a hardwired link to a system under test. Thus, remote stations 130, 131, 132, 133, 134 and 135 may be connected to systems under test 150, 151, 152, 153, 154 and 155, respectively.

The systems under test 150, 151, 152, 153, 154 and 155 may be components of a distributed control system being tested. By way of example only, the control system may be a control system for a nuclear power plant. The systems under test may have different locations throughout the nuclear power plant. The master station 120 may have any desired location within range of wireless communication with the remote stations. The master station 120 typically communicates with the remote stations by wireless communication. However, in some cases, the master station 120 may communicate with one or more remote stations via a wired connection.

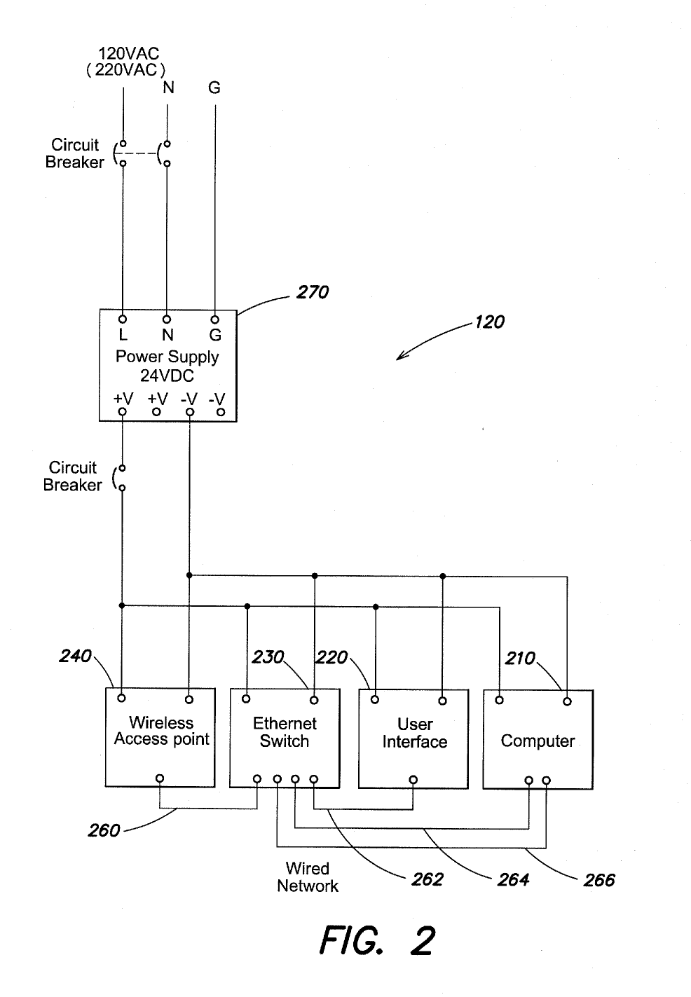

A schematic block diagram of master station 120 in accordance with embodiments of the invention is shown in FIG. 2. The master station 120 may include a computer 210, a user interface 220, an ethernet switch 230 and a wireless access point 240. A wired connection 260 may interconnect wireless access point 240 and ethernet switch 230, a wired connection 262 may interconnect ethernet switch 230 and user interface 220, and wired connections 264 and 266 may interconnect ethernet switch 230 and computer 210. In some embodiments, the user interface 220 can be a touch screen for user inputs and display. In other embodiments, the user interface 220 can include a display screen and a keyboard. A power supply 270 may receive AC power and provide DC power for operation of the components of the master station.

The computer 210 controls operation of the automated test system. The computer 210 receives user inputs and generates user displays via user interface 220. The computer 210 also sends outputs to the systems under test via ethernet switch 230, wireless access point 240 and a selected remote station. The computer 210 also receives inputs from the systems under test via a selected remote station, the wireless access point 140 and ethernet switch 230. The computer 210 runs an application program to execute a test sequence which involves multiple outputs and inputs, storage of inputs from the systems under test and processing of the inputs from the system under test. By way of example only, the computer 210 may compare input values from the system under test with predetermined threshold limits and generate alarms if the input values are outside the predetermined threshold limits. The computer 210 may also communicate with a work station. For example, software and data may be downloaded from the work station and measured input values as well as processed values may be transmitted to the work station.

The ethernet switch 230 serves to control communication between the elements of the master station 120, including the computer 210, the user interface 220 and the wireless access point 240. The wireless access point 240 serves as an interface for wireless communication between the master station 120 and the remote stations 130, 131, 132, 133, 134 and 135 (FIG. 1).

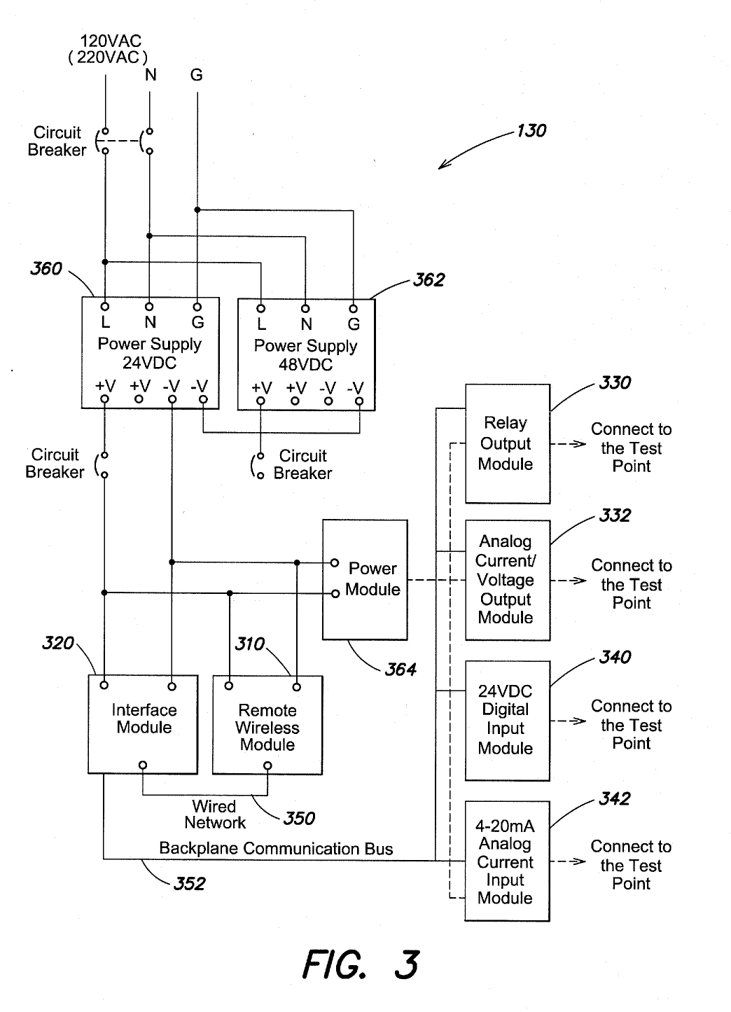

A schematic block diagram of remote station 130 in accordance with embodiments of the invention is shown in FIG. 3. The remote station 130 may include a remote wireless module 310, an interface module 320, at least one output module 330 and at least one input module 340. In the example of FIG. 3, remote station 130 includes a digital output module 330, an analog output module 332, digital input module 340 and analog input module 342. It will be understood that the remote stations 130, 131, 132, 133, 134 and 135 may include different numbers and different types of output modules and input modules, depending on the configuration of the system under test to which the remote station is connected. The input and output modules may be digital, analog or a combination of digital and analog modules. The remote station typically includes at least one output module to send outputs to the system under test and at least one input module to receive inputs from the system under test.

A wired network connection 350 interconnects the remote wireless module 310 and the interface module 320. A wired connection 352 interconnects the interface module 320, the output modules 330 and 332, and the input modules 340 and 342. Power supplies 360 and 362 receive AC input power and provide DC operating power at different voltages to the components of the remote station. A power module 364 provides operating power to output modules 330 and 332 and input modules 340 and 342.

The remote station 130 generates outputs to the system under test based on outputs received by wireless communication from the master station 120. The remote station 130 also receives inputs from the system under test and sends the received inputs to the master station 120 by wireless communication. In some embodiments, the remote station does not perform processing of the outputs and the inputs, other than signal conversion between the outputs received from the master station and the outputs sent to the system under test, and signal conversion between the inputs received from the system under test and the inputs sent to the master station. The signals sent to the system under test are typical standard industrial automation signals, for example 4-20 mA. The simulated signals are the same as those generated by field sensors, such as pressure/flow transmitters. The signals received from the system under test are standard industrial automation signals as well.

The I/O (Input/Output) modules in the remote station may be analog or digital. Digital output modules include a 24 VDC module which outputs 24 VDC only and a relay module which has various AC and DC output voltages for each test point, such as 24 VDC to 48 VDC and 24 VAC to 230 VAC. The analog output modules may include a current output module that can be configured to provide −20 mA to +20 mA or 4 mA to 20 mA for each test point. The resolution may be 15 bits, so the accuracy is 0.1% at full scale range. A voltage output module can be configured to provide −5 VDC to +5 VDC, −10 VDC to +10 VDC, or 1 VDC to 5 VDC for each test point. The resolution may be 15 bits, so the accuracy is 0.1% at full scale range.

The digital input modules may include a 24 VDC input module which takes 24 VDC discrete signal only; a 24/48V input module which can receive 24 VDC, 24 VAC, 48 VDC or 48 VAC discrete signals for each test point; a 120 VAC input module which takes a 120 VAC discrete signal only; and a 230 VAC input module which takes a 230 VAC discrete signal only. Analog input modules may include a current input module which can be configured to receive −20 mA to +20 mA, 4 mA to 20 mA or 0 mA to 20 mA for each test point. A voltage input module can be configured to receive −2.5 VDC to +2.5 VDC, −5 VDC to +5 VDC, −10 VDC to +10 VDC, or 1 VDC to 5 VDC for each test point.

The master station 120 and the remote stations 130, 131, 132, 133, 134, and 135 are preferably configured with a size and weight that facilitates portability. In one embodiment, the master station and the remote stations each have dimensions of 20×20×8 inches and a weight of approximately 40 pounds. The portability feature facilitates movement by a service technician of the master station and the remote stations from one location to another as required.

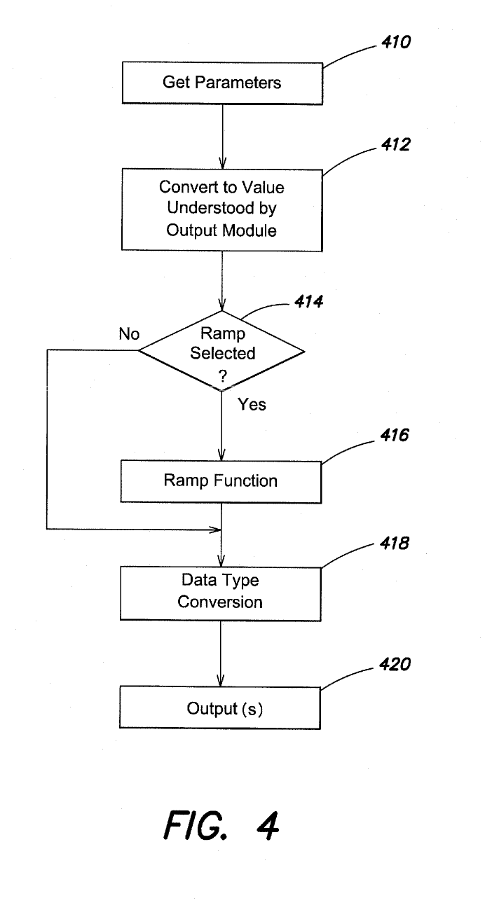

A flow chart of a process for transmitting analog output values to a remote station in accordance with embodiments of the invention is shown in FIG. 4. It will be understood that the process may include additional acts and that the acts of the process may be performed in a different order from that shown in FIG. 4.

In act 410, an analog output is selected. The analog output value may be entered by the user on the user interface 220 or may be a preprogrammed value. In act 412, the selected analog output value is converted to a value that is understood by the output module (such as output module 332 in FIG. 3) that sends the output value to the system under test.

In act 414, a determination is made whether a ramp function has been selected for the user-entered analog output value. By selection of the ramp function, the analog output value is caused to increase from a first value to a second value over a given time period, rather than to rapidly transition between values. For example, the analog value can be caused to increase from 0 to the selected output value over a given time period. The ramp function is applied in act 416. The master station then performs a data type conversion function in act 418. For example, the analog value may be converted from an integer value to a double integer, real value for further operation. If the ramp function is not selected in act 414, the process proceeds directly to the data type conversion function of act 418.

In act 420, the converted output value is sent to the system under test. In particular, the converted output value is transmitted by the wireless access point 240 to one of the remote stations. The remote station converts the received value to an analog value and sends the analog value to the system under test.

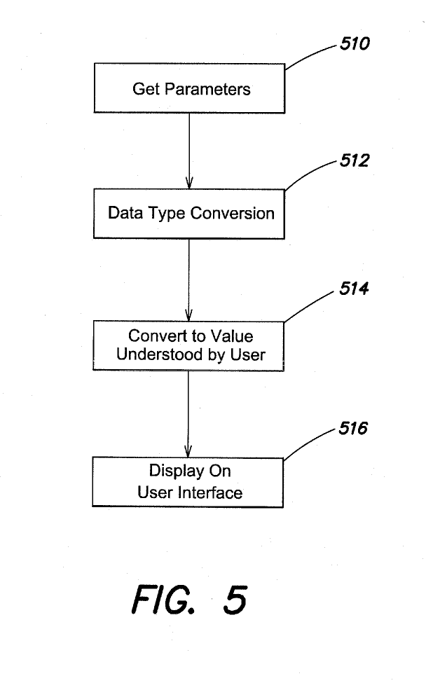

A flow chart of a process for receiving analog input values from a remote station in accordance with embodiments of the invention is shown in FIG. 5. It will be understood that the process may include additional acts and that the acts may be performed in a different order from that shown in FIG. 5.

In act 510, an analog input parameter is received by the master station from one of the remote stations. A data type conversion function is performed in act 512 to convert the parameter to an appropriate data format. In act 514, the output of the data type conversion in to act 512 is converted to a value that is understood by the user. In act 516, the input value is displayed on the user interface 220. The input value may optionally be stored for later processing.

A process for transmitting digital output values to a remote station is described with reference to FIG. 4. In act 410, a digital output is selected and in act 420 the selected digital output is transmitted to one of the remote stations to be sent to the system under test. The digital output may be entered by the user or may be preprogrammed. In the case of a digital output, acts 412, 414, 416 and 418 are omitted.

A process for receiving digital input values from a remote station is described with reference to FIG. 5. In act 510, a digital input is received by the master station from one of the remote stations. In act 516, the digital input is displayed on the user interface 220 and may optionally be stored for later processing. In the case of a digital input, acts 512 and 514 are omitted.

The automated test system of the present invention may be used in either a manual test mode or an automatic test mode, as selected by the user. In manual test mode, the user enters a test value, causes the system to send out the entered test value and receives an input value from the system under test as described above. The user observes the input value on the user interface 220 and judges whether the received input value meets a predetermined condition.

In automatic test mode, the user triggers a test sequence using a push button or other trigger mechanism on the touch screen. The test sequence is defined by preprogrammed logic in the automated test system. The logic defines the output values, how many output values are to be sent and the timing of the output values. For example, the output values may be sent to different test points simultaneously or may be sent to the same or different test points sequentially. After receiving one or more input values from the system under test, the logic verifies whether the received input values meet a predetermined condition. A pass/fail result and the received input values may be displayed on the touch screen. Each test result can be recorded by the user. In some embodiments, the received input values, the pass/fail result and/or other data may be recorded in a storage system for later use and/or for recordkeeping purposes.

The test sequence to be performed typically determines whether to use manual test mode or automatic test mode. For time dependent, simultaneous and closed loop test cases, the automatic test mode must be utilized.

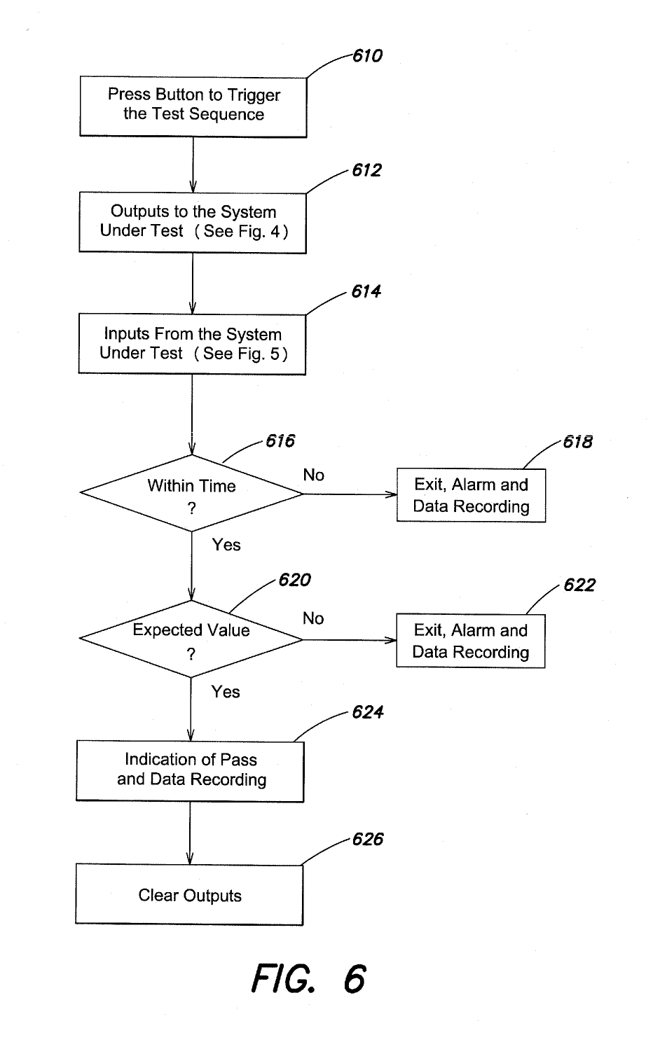

A flow chart of automatic system operation in accordance with embodiments of the invention is shown in FIG. 6. It will be understood that the process may include additional acts and that the acts may be performed in a different order from that shown in FIG. 6.

In act 610, the user presses a button to trigger the automatic test sequence. For example, the button may be a soft button on the touch screen. In act 612, the master station sends the output values for the test sequence to the system under test as shown in FIG. 4 and described above. The output values may include a single output value or two or more output values. The output values may be sent to the same test point or to different test points. The output values may be sent to different test points simultaneously or sequentially, with any desired timing. As described above, each output value is transmitted by the master station to one of the remote stations. The remote station sends the output value to the system under test and, in response, receives an input value. The received input value is transmitted back to the master station by wireless communication.

In act 614, the master station receives input values from the system under test via the remote station as described above in connection with FIG. 5. The input values are responsive to the output values transmitted in act 612. In act 616, the master station determines whether each input value has been received within a timeout period. If the received value is received later than the timeout period or is not received at all, the process proceeds to act 618. In act 618, the master station exits the automatic test mode, generates an alarm and records related data, such as the received input value or lack thereof, the alarm and the time and date. The alarm may be a visual alarm, such as a flashing indicator on the touch screen, an audible alarm, or both.

In act 620, the master station evaluates the received input value to determine if it matches an expected value. For example, the received input value may be compared with upper and lower limits to determine if it is within a range of expected values. If the received input value is not within the range of expected values, the process proceeds to act 622. In act 622, the master station exits the automatic test sequence, generates and alarm and records data related to the received input value as described above in connection with act 618.

If the received input value is received within the timeout period, as determined in act 616, and is within the range of expected values, as determined in act 620, the master station, in act 624, generates a pass indication and records related data, such as the received input value, the pass indication and the time and date. The pass indication, for example, may be an indication on the touch screen. In act 626, the master station clears the outputs for a subsequent test sequence.

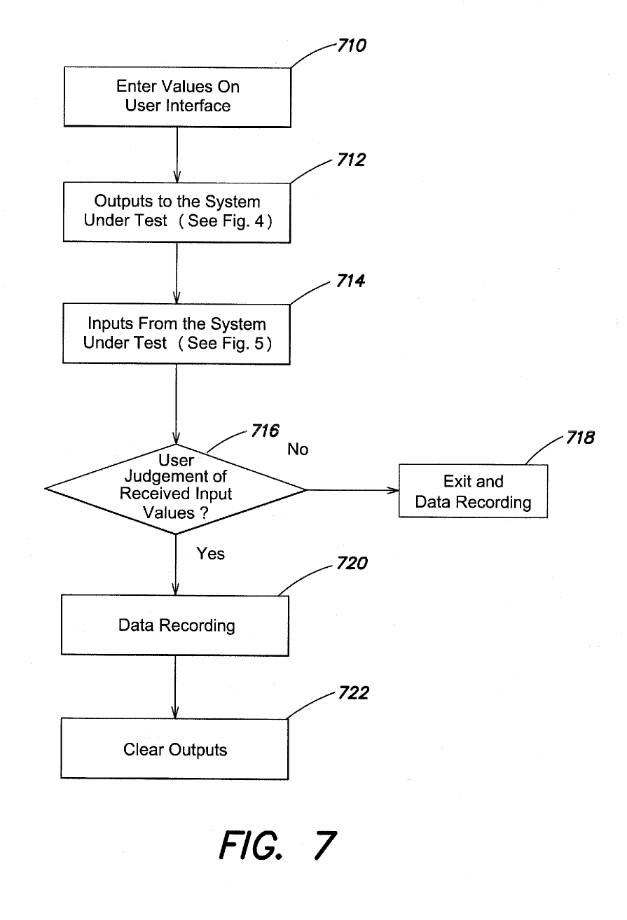

A flow chart of manual system operation in accordance with embodiments of the invention is shown in FIG. 7. It will be understood that the process may include additional acts and that the acts may be performed in a different order from that shown in FIG. 7.

In act 710, the user enters one or more values on the user interface 220, such as the touch screen. In act 712, the user entered values are output to the system under test as shown in FIG. 4 and described above. In act 714, the master station receives one or more input values from the system under test as shown in FIG. 5 and described above. In particular, the master station transmits the output value to the remote station by wireless communication, and the remote station transmits the output value to the system under test. The remote station receives an input value from the system under test in response to the output value and transmits the received value to the master station.

In act 716, the user makes a judgment with respect to the received input value or values displayed on the touch screen. For example, if the received input value is received later than expected or no input value is received, the user judges that a system malfunction has occurred and proceeds to act 718. If an input value is received within the timeout period, the user judges whether the received input value is within a range of expected values, for example, by comparing the received input value with upper and lower limits If the received input value is outside the range of expected values, the user proceeds to act 718. In act 718, the user exits the manual test mode and records the relevant data.

If the received input value is received within the timeout period and is within the expected range, the user proceeds to act 720. In act 720, the relevant data is recorded. In act 722, the outputs are cleared for a subsequent test sequence.

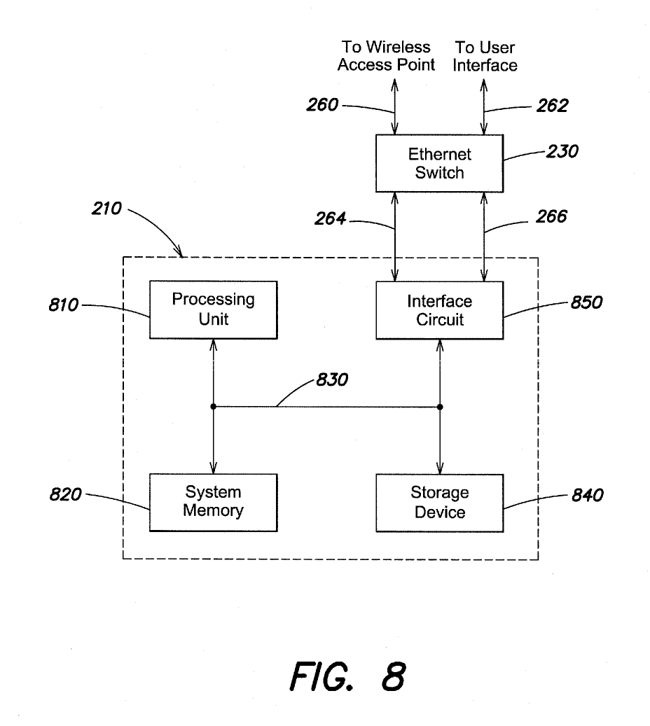

A schematic block diagram of a computing system used in the master station, in accordance with embodiments of the invention, is shown in FIG. 8. The computing system of FIG. 8 is only one example of a suitable computing system and is not intended to suggest any limitation as to the scope of use or functionality of the invention. The invention is operational with numerous other general purpose or special purpose computing systems and configurations. Examples of well known computing systems and configurations that may be suitable for use for the invention include, but are not limited to, personal computers, server computers, handheld or laptop devices, multiprocessor systems and the like.

The computing system may execute computer-executable instructions, such as program modules. Generally, program modules include routines, programs, objects, components, data structures, etc. that perform particular tasks or implement particular data types. The invention may also be practiced in a distributed computing system where tasks are performed by remote processing devices that are linked through a communications network. In a distributed computing system, program modules may be located in both local and remote computer storage media including memory storage devices.

As shown in FIG. 8, computer 210 may include a processing unit 810, a system memory 820 and a system bus 830 that couples various system components, including the system memory 820 to the processing unit 810. Computer 210 typically includes a variety of computer-readable media. Computer readable media can be any available media that can be accessed by processing unit 810 and includes both volatile and non-volatile media, and removable and non-removable media. The computer 210 of FIG. 8 includes storage device 840 which may include, but is not limited to, RAM, ROM, EEPROM, flash memory or other memory technology, CD-ROM, digital versatile discs (DVD) or other optical disc storage or magnetic storage devices, or any other medium which can be used to store information and which can be accessed by processing unit 810. The computer 210 may be connected to ethernet switch 230 through an interface circuit 850 and connections 264 and 266.

Having thus described several aspects of at least one embodiment of the invention, it should be appreciated that various alterations, modifications, and improvements will readily occur to those skilled in the art. Such alterations, modifications, and improvements are intended to be part of this disclosure, and are intended to be within the spirit and scope of the invention. Further, although advantages of the present invention may be indicated, it should be appreciated that not every embodiment of the invention will include every described advantage. Some embodiments may not implement features described herein as advantageous. Accordingly, the foregoing description and drawings are by way of example only.

What is claimed is:

1. An automated test system comprising:
a master station including a processing unit operably coupled to a user interface and a master wireless unit; and
at least one remote station including at least one output module to send outputs to a unit under test, at least one input module to receive inputs from the unit under test and a remote wireless unit operably coupled to the at least one output module and the at least one input module, wherein the master station is configured to transmit outputs to the remote station by wireless communication and to receive inputs from the remote station by wireless communication, the received inputs being representative of a condition of the unit under test.

2. An automated test system as defined in claim 1, wherein the at least one remote station comprises two or more remote stations and wherein the master station is configured to communicate with the two or more remote stations by wireless communication.

3. An automated test system as defined in claim 1, wherein the user interface comprises a touch screen.

4. An automated test system as defined in claim 1, wherein the at least one input module comprises a digital input module and/or an analog input module, and wherein the at least one output module comprises a digital output module and/or an analog output module.

5. An automated test system as defined in claim 1, wherein the at least one remote station has a size and weight configured for portability.

6. An automated test system as defined in claim 1, wherein the master station is configured to ramp a selected analog output from a first value to a second value.

7. An automated test system as defined in claim 2, wherein the two or more remote stations are configured to communicate with distributed control elements of a facility.

8. An automated test system as defined in claim 1, wherein the master station is configured to store the received inputs.

9. An automated test system as defined in claim 2, wherein the master station is selectably operable in an automatic test mode or in a manual test mode.

10. An automated test system as defined in claim 9, wherein the master station is configured to simultaneously transmit two or more outputs to at least two remote stations in the automatic test mode.

11. An automated test system as defined in claim 9, wherein the master station is configured to sequentially transmit two or more outputs to one or more remote stations in the automatic test mode.

12. An automated test system as defined in claim 9, wherein the master station is configured to determine whether an input has been received within a timeout period in the automatic test mode.

13. An automated test system as defined in claim 9, wherein the master station is configured to determine whether an input is within upper and lower limits in the automatic test mode.

14. A method for automated testing of a control system, comprising:
generating an output at a master station;
transmitting the output from the master station to a remote station by wireless communication;
transmitting the output from the remote station to a unit under test;
receiving, by the remote station, an input from the unit under test in response to the output;
transmitting the input from the remote station to the master station by wireless communication; and
receiving, by the master station, the input, the received input being indicative of a condition of the unit under test.

15. A method for automated testing as defined in claim 14, further comprising:
transmitting outputs from the master station to two or more remote stations; and
receiving inputs from the two or more remote stations.

16. A method for automated testing as defined in claim 14, further comprising:
the master station ramping a selected analog output from a first value to a second value

17. A method for automated testing as defined in claim 14, further comprising:
storing the received input.

18. A method for automated testing as defined in claim 14, further comprising:
selectably operating the master station in an automatic test mode or a manual test mode.

19. A method for automated testing as defined in claim 18, further comprising:
simultaneously transmitting outputs to at least two remote stations in the automatic test mode.

20. A method for automated testing as defined in claim 18, further comprising:
sequentially transmitting output values to one or more remote stations in the automatic test mode.

21. A method for automated testing as defined in claim 18, further comprising:
determining if an input is received from a remote station within a timeout period in the automatic test mode.

22. A method for automated testing as defined in claim 18, further comprising:
comparing the received input with upper and lower limits in the automatic test mode.

23. An automated test system comprising:
a master station including a processing unit operably coupled to a user interface and a master wireless unit; and
multiple remote stations configured for wireless communication with the master station and for wired communication with respective units under test, each remote station including one or more output modules to send outputs to a respective unit under test, one or more input modules to receive inputs from the respective unit under test and a remote wireless unit operably coupled to the one or more output modules and the one or more input modules, wherein the master station is configured to transmit outputs to each of the remote stations by wireless communication and to receive inputs from each of the remote stations by wireless communication, the received inputs being representative of one or more conditions of the units under test.
